(19) United States
(12) Patent Application Publication
(10) Pub. No.: US 2014/0379316 A1
(43) Pub. Date: Dec. 25, 2014

(54) SIMULATION OF ANGLING CASTS AND CASTING TACKLE

(71) Applicant: QMP Enterprises Inc., Phoenix, NY (US)

(72) Inventor: Thomas William Murphey, Albuquerque, NM (US)

(21) Appl. No.: 14/311,746

(22) Filed: Jun. 23, 2014

Related U.S. Application Data
(60) Provisional application No. 61/838,324, filed on Jun. 23, 2013.

(51) Int. Cl. G06F 17/50

(52) U.S. Cl. CPC G06F 17/5009
USPC 703/6

(57) ABSTRACT

The design of angling casts and casting tackle to achieve better casting performance uses mathematical models to represent the structural dynamics and aerodynamics of the cast and casting tackle. Computer simulations analyze the models to predict cast and casting tackle behavior and assess performance. Modification of model parameters allows the cast and casting tackle to be quickly designed to meet a range of performance goals.

### CROSS REFERENCE TO RELATED APPLICATION

The present patent application is a nonprovisional of, and claims the benefit of, U.S. Provisional Patent Application Ser. No. 61/838,324, entitled “ANGLING CASTS AND CASTING TACKLE”, filed Jun. 23, 2013, the disclosure of which is incorporated herein by reference in its entirety.

### BACKGROUND OF THE INVENTION

The present invention is in the field of angling using a rod, reel, line, terminal tackle, and casting. More particularly, it is in the field of the design of casts (e.g., motions of the fishing rod to transport terminal tackle such as a fish-hook into a body of water) and the tackle (e.g., fish-hooks, lines, and fishing rods) used in casting. Current techniques for designing casts and tackle involve considerable trial and error. There is, therefore, a need for improved methods, systems, and apparatus for the design of angling casts and casting tackle.

### BRIEF DESCRIPTION

A system comprises a network, computer, software, and apparatus for the design of angling casts and casting tackle. The cast and casting tackle are numerically represented and computer simulations are used to predict the behavior of the cast and casting tackle. The system is used to numerically modify design parameters to achieve a desired goal. The systems results in better cast designs, better casting tackle designs, and casts and casting tackle tailored to each other and to the angler.

In one embodiment, an apparatus is used to design angling casts and casting tackle using computer simulations to supplement or replace the intuition of the designer. An objective is to design the cast, rod, line, and terminal tackle using a computer system. A second objective is to enable computer simulation based design iterations. An additional objective is to reduce the time required to perform design iterations. An additional objective is to allow numerical optimization of casts and casting tackle. An additional objective is to provide greater knowledge and understanding of casts and casting tackle performance through computer simulation.

These objectives are realized through a design method based on simultaneous structural dynamic and aerodynamic computer simulation of the combined cast, rod, line, and terminal tackle system. The tackle is defined by design parameters (e.g. rod length, rod diameter, rod material properties, line mass, line diameter, and line stiffness) and is numerically modeled. Cast definitions (descriptions of how the rod is moved by the angler) are created to drive the rod and line. External phenomena impacting the cast are also modeled in the computer simulation and can include gravity, air drag, and wind.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1A shows an angler, rod, reel, line, and terminal tackle. The two casting degrees of freedom of wrist angle and wrist translation about the sagittal plane are also shown.

FIG. 1B shows the six motion degrees of freedom used in the cast definition with reference to the orientation of the human body planes and an additional set of six degrees of freedom referenced to an arbitrary orientation.

FIG. 2A and FIG. 2B are examples of a cast defined by wrist angular velocity and translational velocity degrees of freedom as a function of time.

FIG. 3A and FIG. 3B are examples of angular position and angular acceleration calculated from cast definition angular velocity.

FIG. 4A and FIG. 4B are examples of translational position and translational acceleration calculated from cast definition translational velocity.

FIG. 5A through FIG. 5P shows a sequence of frames from a fly casting computer simulation.

FIG. 6 is a computer simulation example of fly casting performance as measured by moment (torque) applied at the wrist by the angler.

FIG. 7 is a computer simulation example of fly casting performance as measured by line kinetic energy.

FIG. 8 is a computer simulation example of fly casting performance as measured by the path traced by the terminal tackle (e.g., a fly) during casting.

FIG. 9 is a computer simulation example of fly casting performance as measured by the path traced by the tip of the rod during casting.

FIG. 10A through FIG. 10H show a sequence of frames from a computer simulation of fly casting where line shooting occurs.

FIG. 11 shows a flow chart describing steps according to various embodiments.

FIG. 12A shows an exemplary computational and information network.

FIG. 12B shows an exemplary computer system for modeling, simulation, data acquisition, and data processing according to various aspects.

### DETAILED DESCRIPTION

In an embodiment, casting tackle is designed using a computer implemented iterative method including displaying a simulation of the performance of the designed casting tackle. Parameter inputs may be modified until the simulated performance of the casting tackle is satisfactory. The tackle designer may set goals for casting performance. The goals relate to cast characteristics such as distance, accuracy, efficiency, as well as angler range of motion, strength, and skill level. Goals may also relate to the tackle, for example, line tension during casting and rod loading during casting. Based on experience, the designer attempts to design the tackle to meet the goals. In one embodiment, the display of the casting tackle simulation may include a series of numerical outputs descriptive of the cast characteristics. In another embodiment, the display of cast performance may include an animated image of a cast, such as a depiction of a fishing rod and fishing line, which may be presented as a moving digital image or as a series of digital still images on an electronic display such as a computer monitor.

Design here refers to the selection of design parameters and the specification of values for these parameters. Rod design includes selecting rod length, material type, material orientation, and material distribution in the rod. The parameters may include numerical values representing the design parameters that are input into a computer simulation program. It includes all characteristics that affect the cast and casting. For example, fishing rods often have tapered tubular forms. Rod geometry for this is a circular cross section, whose diameter may be referred to herein one of the parameters that affects casting performance, and geometric design includes determining the inside and outside diameters of the rod as a function of position along the length of the rod. Unique rod performance features are achieved through specification of design parameter values, inputting, or storing, these values in an electronic memory to be accessed by computerized simulation software when a simulation of designed fishing rod and fishing line is desired. Line design, i.e. additional parameters, may include specifying the line construction (monofilament, braided or fused fibers) and diameter. In fly casting, line design involves the additional parameters (that vary along the length of the line) of mass, bending stiffness, and damping. Terminal tackle (e.g. lures and artificial flies) design involves mass and wind resistance parameters. Cast design involves specifying the rod motion (rod handle rotations and translations as a function of time as would be imparted by the angler) and specifying the line motion (paying line out from the rod and pulling line in as would be imparted by the angler during casting). These specifications may be referred to herein as parameters. Typically, the parameters are specified by numerical values that are stored in computer accessible memory so that a simulation of the cast performance may be obtained by executing a simulation program based on the input parameters.

In one embodiment, design of casts and casting tackle relies on the experience of the designer to specify, as a numerical input, design parameters to achieve desired casting goals. Based on experience, design parameter values are specified, simulated, modified, simulated again, until performance is satisfactory and then physical prototypes are fabricated. The prototypes may be tested again.

In one embodiment, a computer simulation correctly models the relationship between design parameters and cast performance and is used to design the cast and casting tackle. Through computer simulations, design parameter values are specified and the performance goals are assessed. Using manual or automated iterative methods, design parameters are modified and the computer simulation is used to find designs that best meet performance goals. The computer simulation may also be used to optimize the design parameters.

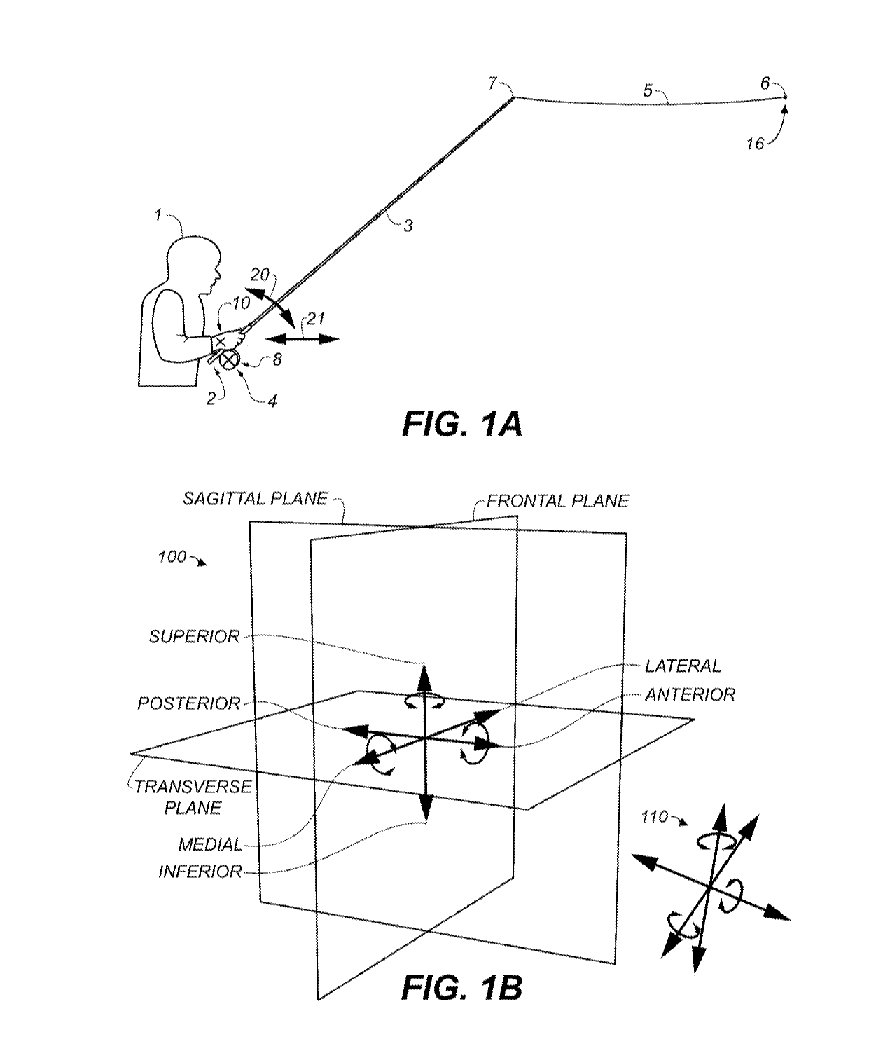

With reference to FIG. 1, in one embodiment a computer simulation is used to model the structural dynamic and aerodynamic behavior of the rod 3, reel 4, line 5 and terminal tackle 6 during casting. The model allows design parameter values (geometry, material constitutive behavior, etc.) to be changed to represent specific designs. The cast is input to the model as a prescribed motion at the casting reference point, wrist 10, for example, which may be described as a rigid connection with the rod handle 2. Factors in the casting environment (e.g., gravity, air drag, and wind) are modeled as loads on the casting tackle. These parameters may be referred to herein as control aspects that are stored and modified to control the depicted simulation of the cast performance.

The model is created using kinematic, structural dynamic, and aerodynamic simulation algorithms implemented in software and executed on a networked computer system or at a standalone workstation. In one embodiment, the system solves the dynamic equations of motion derived from Newton's second law: the net force on an object is equal to the rate of change of its momentum. The equations and solutions vary with time, position, geometry, system material properties, system boundary conditions, and system loads. The equations are a system of partial differential equations and various techniques may be used for their solution, for example, implicit and explicit methods. Large deformation structural dynamic finite element and finite difference algorithms are appropriate. These methods are available as commercial general purpose codes or custom analysis codes may be developed. A combination of commercially available and custom codes may also be used. As an example, commercially available programs suitable for solving systems of equations or modeling various mechanical systems include MATHEMATICA and ABAQUS. In alternative embodiments, the simulations are based on additional methods from the fields of mechanics and analytical dynamics, including continuum and discretized methods.

The cast design parameters, i.e., control aspects, describe how the rod handle is moved by the angler as a function of time. A set of cast design parameters and their variation with time is called a cast definition. The cast definition may include three rotational degrees of freedom of the rod handle 2 with respect to a stationary frame of reference. While the rod handle is generally flexible, a short portion of the rod handle may be considered to be a rigid body. Rod handle rigid body motions are defined by the translational and rotational degrees of freedom of a notional cast reference point that is considered rigidly connected to the rod handle rigid body. The cast reference point may be located arbitrarily and is generally not located on the rod handle. The geometric center of wrist 10 is a convenient cast reference point. A set of cast degrees of freedom comprising a cast definition is: (1) rotation about an axis passing through the geometric center of the wrist 10 and perpendicular to the sagittal plane of the angler, (2) rotation about an axis passing through the geometric center of the wrist 10 and perpendicular to the frontal plane of the angler, and (3) rotation about an axis passing through the geometric center of the wrist 10 and perpendicular to the transverse plane of the angler. Any or all of these parameters may be defined by a numerical value indicating a magnitude of rotational, or angular, velocity, in terms of distance and time, or in terms of angular displacement and time, for example. The cast definition may also include numerical values representing three translational degrees of freedom of the geometric center of the casting wrist 10: (4) anterior/posterior translation, (5) superior/inferior translation and (6) medial/lateral translation. This cast definition uses a coordinate system defined by the planes of the human body. Any or all of these parameters may be defined by a numerical value indicating a magnitude of velocity, in terms of distance and time, or in terms of distance, direction, and time, for example.

The cast degrees of freedom may be defined with respect to any other convenient casting reference point and coordinate system. For example, rotation about an axis parallel to the long axis of the rod and translation in a direction parallel to the long axis of the rod may be used as degrees of freedom. The casting reference point may be a point other than the geometric center of the wrist. For example, a point coincident with the center of mass of the reel 8 could be used. An arbitrary casting reference point, coordinate system with three translational and three rotational degrees of freedom are shown in FIG. 1B. In FIG. 1B, coordinate systems 100 and 110 are shown. The coordinate systems have the same degrees of freedom, and different parameters for those degrees of freedom (e.g., different axis orientations or positions).

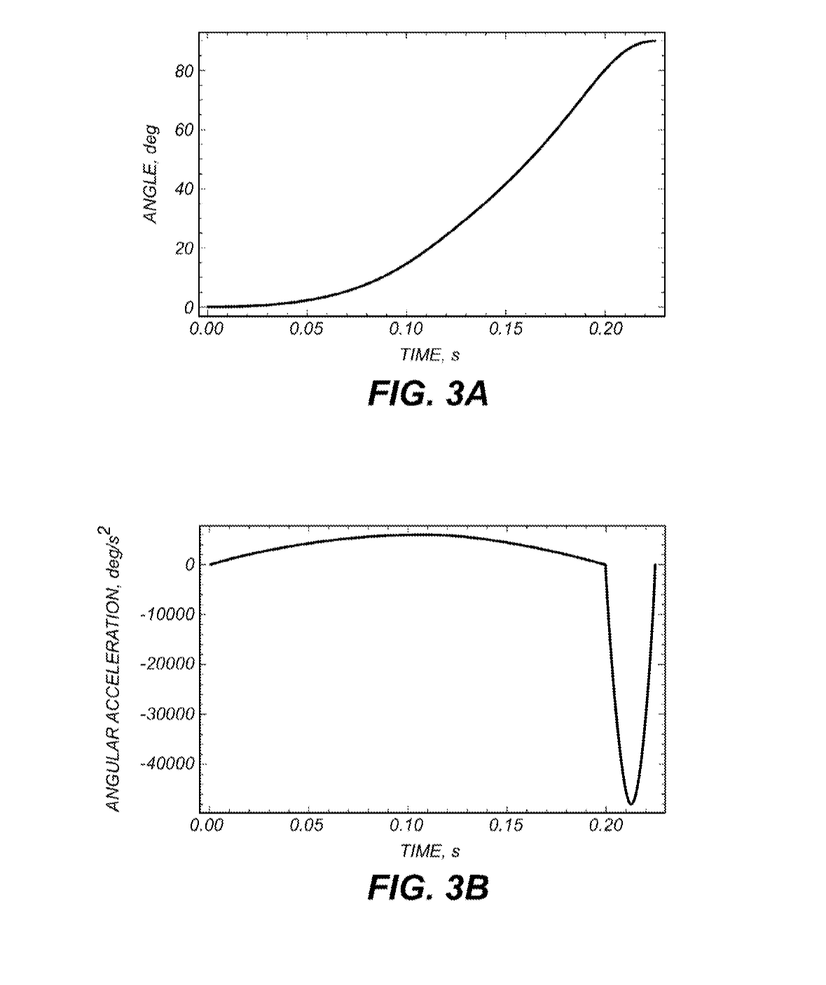

The cast definition, which may be referred to herein as an aggregate of casting parameters or control aspects, determines how the rod 3 moves and loads the line 5, which, in turn, determines how the simulation of the cast is calculated and displayed. In general, the rod experiences various motions throughout a cast. For example, at a time t₀, which may represent a beginning time or a start time of the simulation, the rod starts from a relatively motionless state. The rod is then accelerated to impart load on the rod and line, and subsequently is decelerated to a relatively motionless state to achieve the desired cast. At the end of the cast, i.e. the ending time or finish time t₂, the rod and line may also reach a relatively motionless state. An intermediate point in time, such as a transitional time t₁ when the rearward motion of rod 3 begins to slow (e.g., angular acceleration crosses zero, e.g., as shown in FIG. 3B), can also be specified using the same parameters as the beginning time definition and the finish time definition. The cast is defined by changes in the casting reference point (and hence, rod handle) motion degrees of freedom with time. The changes include variations in position/angle, velocity/angular velocity, and acceleration/angular acceleration with time.

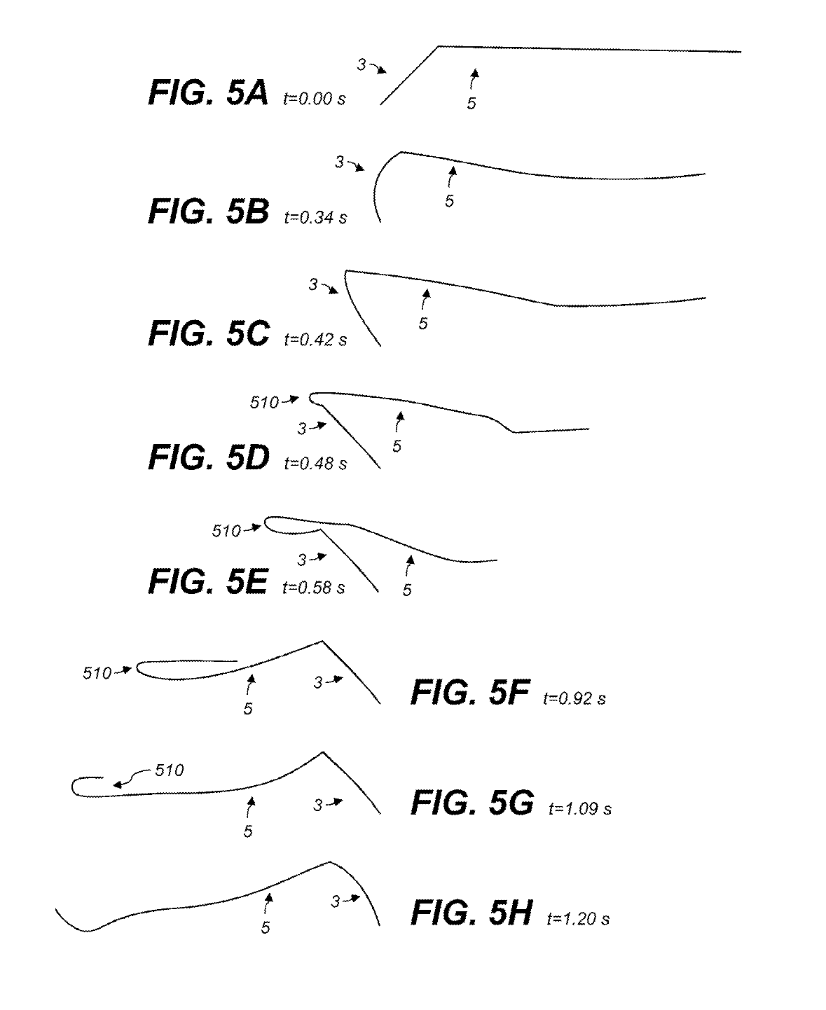

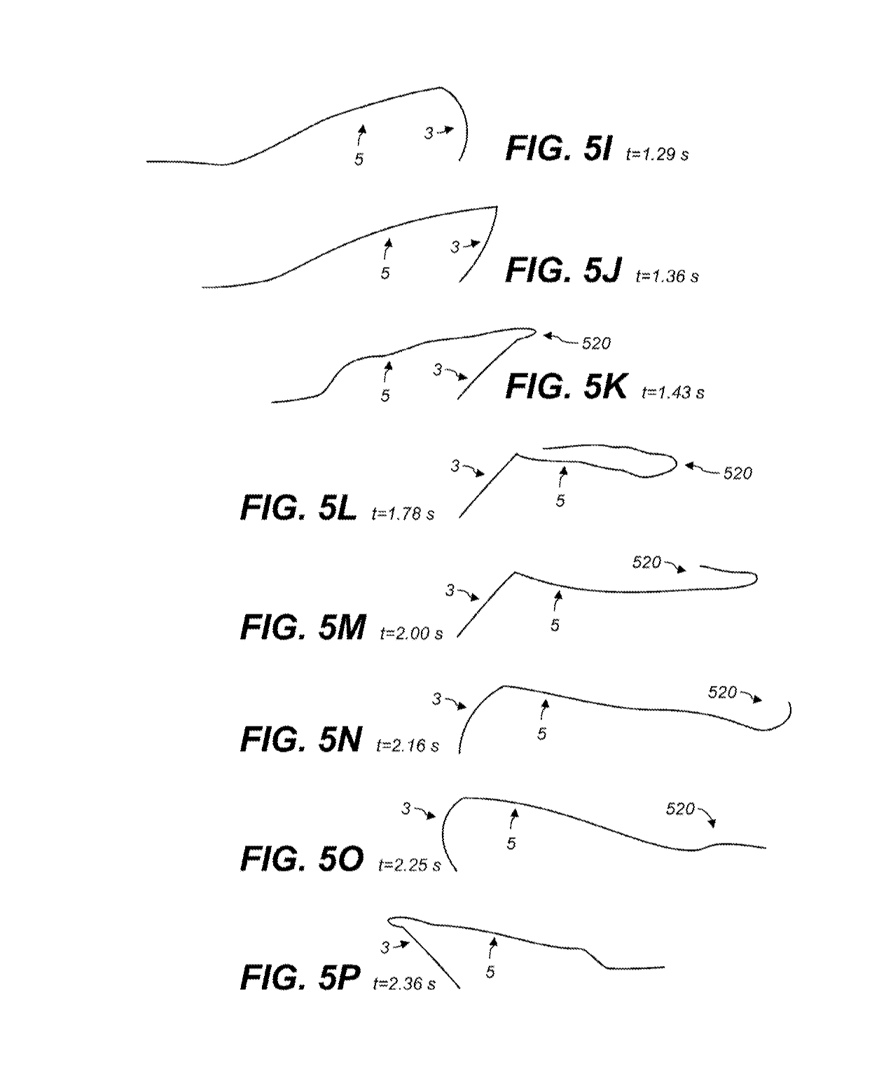

In various embodiments, feedback is used in the cast definition. Bending of the rod, position of the rod, line load, or other physical states of the rod or tackle are calculated during the computer simulation and are used as feedback parameters that are used to actively control (calculate) the cast definition throughout a computer simulation and may lead to a more accurate display of the cast performance (e.g., as discussed below with reference to FIGS. 5A-5P).

In various embodiments, the cast is defined from measurements of rod handle motions imparted by an angler or machine physically casting a rod.

In various embodiments, the cast is defined from measurements of casting tackle made on an angler or machine physically casting a rod. Example measurements are rod load, rod bending, line tension, line speed, etc.

In various embodiments, the cast is defined based on moments and forces applied to the rod 3 by the angler 1 as a function of time. The loads may actuate the six cast degrees of freedom or they may be defined with respect to another suitable cast reference point.

In various embodiments, the cast is defined by specifying the kinematics of all or portions of a human body (e.g., the body of angler 1). For example, the geometry and motions of the shoulder and arm of an angler could be used to define the motions of the rod handle.

In various embodiments, the cast is defined by measurements of the kinematics of all or portions of the human body of angler physically casting.

In various embodiments, the structural mechanics of the human body are modeled in the computer simulation.

In various embodiments, the cast is defined by the motions of the two degrees of freedom shown in FIG. 1. The first is rotation of the rod about an axis located at the wrist and perpendicular to the sagittal plane of the angler 1, indicated by wrist angle 20. This motion is specified by the wrist angle. The second motion is an anterior/posterior motion of the wrist 10. This motion is specified by the wrist translation 21.

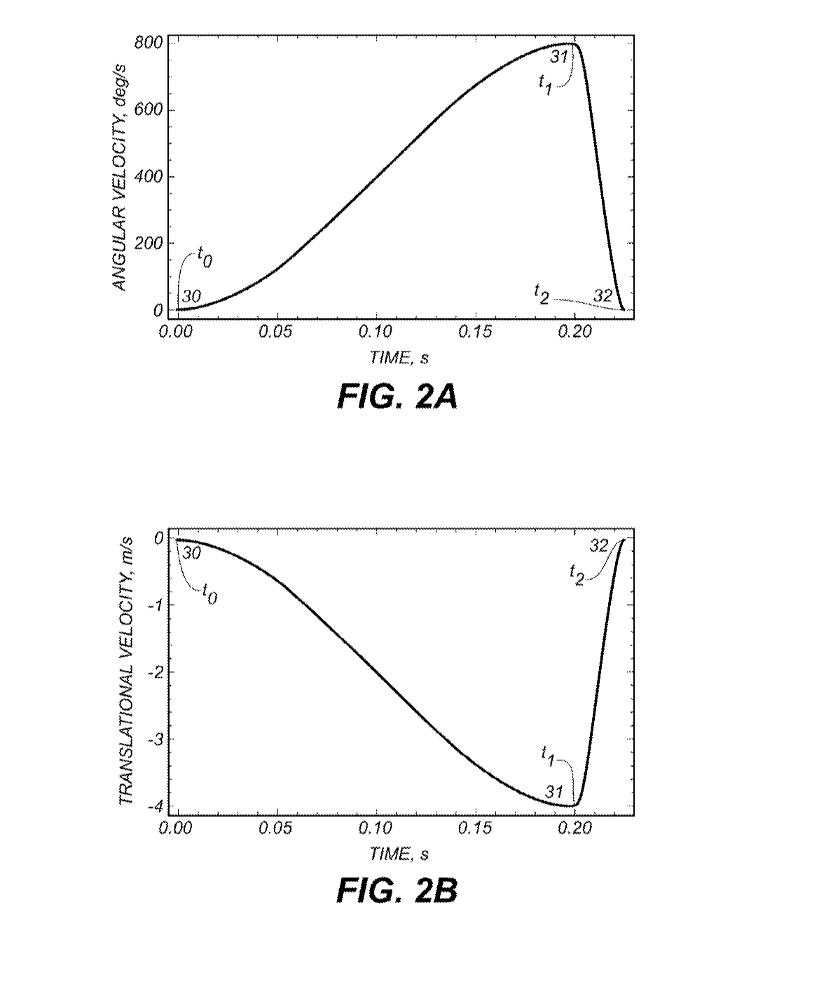

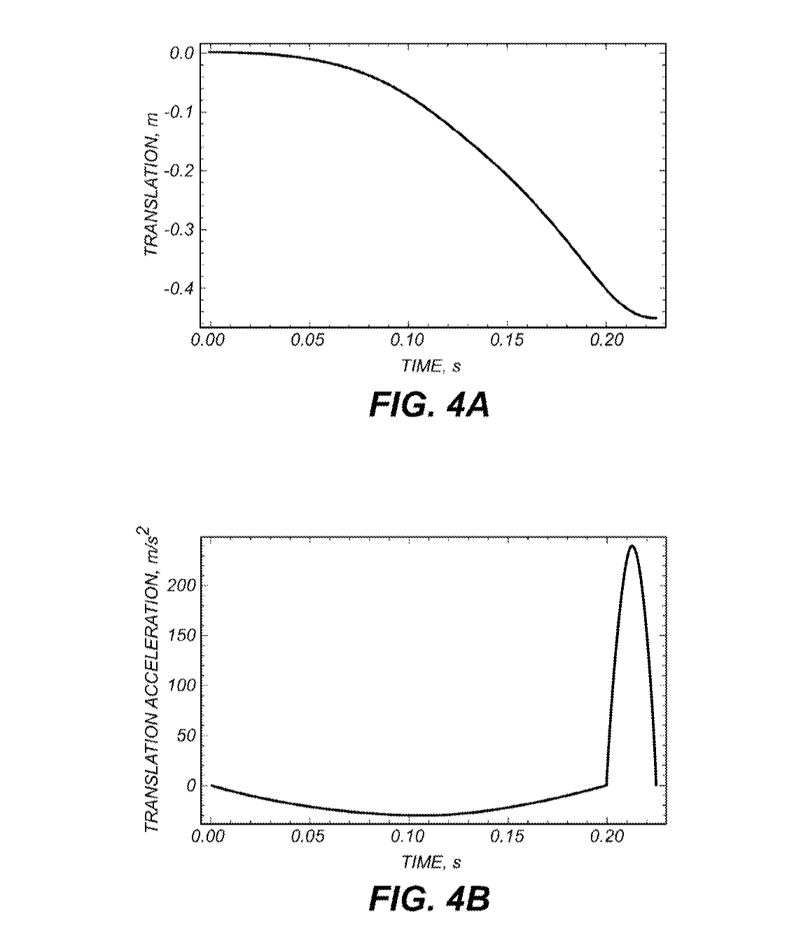

FIGS. 2A-4B show an exemplary cast definition. FIG. 2A shows wrist angular velocity, FIG. 2B shows wrist translational velocity, FIG. 3A shows wrist angular position, FIG. 3B shows the angular acceleration, FIG. 4A shows the translational position and FIG. 4B shows the translational acceleration. In an alternative embodiment, the cast degrees of freedom are defined at control points. Using the two degree of freedom example of the previous paragraph, wrist angle 20 and wrist translation 21 are specified at three points in time called control points. The points are located as follows: at the beginning of the cast (time t=t₀), point 30; at the point of maximum angular velocity in the cast (time t=t₁), point 31; and at the end of the cast (time t=t₂), point 32. Time, angular velocity, and angular acceleration are specified for wrist angle at each of the three control points and are used as numerical inputs into the computer implemented simulation program. Similarly, time, velocity, and acceleration are specified for wrist translation at each of the three control points. Interpolation functions (e.g., third order polynomial functions) are used for both wrist angular and wrist translational velocity to define the cast in the time between control points. The functions interpolate between the control points while matching the angular and translational velocity and acceleration specified for each control point. The functions are mathematically integrated to find degree of freedom positions and mathematically differentiated to find degree of freedom accelerations. In this example, the curve shown in FIG. 2A can be integrated to provide the curve shown in FIG. 3A or differentiated to provide the curve shown in FIG. 3B. The curve shown in FIG. 2B can be integrated to provide the curve shown in FIG. 4A or differentiated to provide the curve shown in FIG. 4B.

The cast degrees of freedom may be defined using control points that specify time, position, and velocity. In this case, the interpolation functions are defined for positions t₀, t₁, and t₂, and they are mathematically differentiated to find velocity and acceleration. In alternative embodiments, the cast degrees of freedom may by defined using control points that specify time, position, velocity and acceleration. An interpolation function with sufficient freedom (e.g. a fourth order polynomial) is required to match all specified quantities. In alternative embodiments, the cast degrees of freedom may by defined using control points that specify time, position, velocity, acceleration and jerk (rate of change of acceleration). An interpolation function with sufficient freedom (e.g. a fifth order polynomial) is required to match all specified quantities.

In alternative embodiments, the number of control points is less than three or greater than three.

In an alternative embodiment, the control points define motions of more than two degrees of freedom. For example, the control points can define motions of two translational degrees of freedom of wrist motion (anterior/posterior and lateral/medial), or two rotational degrees of freedom. The degrees of freedom can also be expressed in alternative coordinate systems, e.g., a cylindrical coordinate system in which translation of wrist 10 is expressed in terms of the distance of wrist 10 from the body of angler 1, the direction in which angler 1 is extending wrist 10, and the height of wrist 10 with respect to, e.g., the shoulder or waist of angler 1.

In an alternative embodiment, the number of parameters required to define a cast is reduced. In an example, the cast is assumed to start at t₀=0, at an angle of zero and at a translation of zero. The wrist is assumed to be motionless and not accelerating at this time with respect to both angle and translation. Similarly, the wrist is assumed to be motionless and not accelerating at the end of the cast. Wrist accelerations are assumed to be zero at t₁. These assumptions reduce the number parameters required to describe a cast to four: the wrist angular and translational velocities at t₁ and the values for t₁ and t₂.

In an alternative embodiment, the cast parameters from the previous paragraph are expressed as angular position and translational position. The desired wrist angle at t₁ can be specified and used to calculate the angular velocity required to achieve said angle. Next, the desired wrist angle at t₂ can be specified and used to calculate the value of t₂ required to achieve said angle. Finally, the wrist translation at t₁ can be specified and used to calculate the translational velocity required to achieve said translation. Using this method, the cast is defined by the three physically significant parameters of wrist angle, wrist translation, and the time required to achieve maximum velocity.

Following the above method, where the time at maximum velocity is 0.2 s and at this time, the wrist angle is 80 deg and the wrist translation is −0.4 m, and where the wrist angle at the end of the cast is 90 deg, results in the cast definition plots shown in FIGS. 2A-4B. For both angle and translation, the plots show position, velocity, and acceleration, as noted above.

FIG. 5A through FIG. 5P show a time sequence of computer simulation results for fly casting over the course of a cast lasting about 2.36 seconds. Rod 3 and line 5 were simulated and are shown. The times t for the figures are given in Table 1, below. This simulation is an example of a fly casting computer simulation. A plurality of identical or different cast definitions can be used to simulate a back cast followed by a forward cast.

TABLE 1

| FIG. | Time t (sec) |
|---|---|
| 5A | 0.00 |
| 5B | 0.34 |
| 5C | 0.42 |
| 5D | 0.48 |
| 5E | 0.58 |
| 5F | 0.92 |
| 5G | 1.09 |
| 5H | 1.20 |
| 5I | 1.29 |
| 5J | 1.36 |
| 5K | 1.43 |
| 5L | 1.78 |
| 5M | 2.00 |
| 5N | 2.16 |
| 5O | 2.25 |
| 5P | 2.36 |

The cast initiates with a back cast, shown in FIGS. 5A-5G. A characteristic loop 510 of fly casting is visible in FIG. 5D and is present through FIG. 5G. In FIG. 5H, a forward cast is initiated. In FIG. 5K, there is shown a loop 520 that is present through FIG. 5O. This sequence of back and forward casts can be repeated indefinitely by angler 1 or in simulation as steady state casting and is called false casting. The cast definition parameters can also be changed with each cast to approach desired casting goals such as duration of cast or travel distance of terminal tackle 6.

Other casts besides the illustrated fly cast can be modeled, for example, mending, side casts, roll casts, switch casts, two handed casts, spey casts, underhand casts, pitching and flipping. Line retrieval can also be modeled and may include, for example, techniques known as stripping and jigging. Moreover, in various aspects, air drag and water drag can be modeled. This can be done, e.g., using the Rayleigh drag equation F_{D}=0.5ρv²C_{D}A (force is proportional to fluid mass density, squared relative velocity, drag coefficient, and reference area) or other fluidic-drag models. Air drag and water drag can be modeled using the same equations but respective, different coefficients.

In various embodiments, the cast and casting tackle are designed and assessed by several performance measures independently or in combination. Examples of performance measures are casting distance, casting accuracy, rod loading, cast efficiency and tolerance to novice angler skill levels.

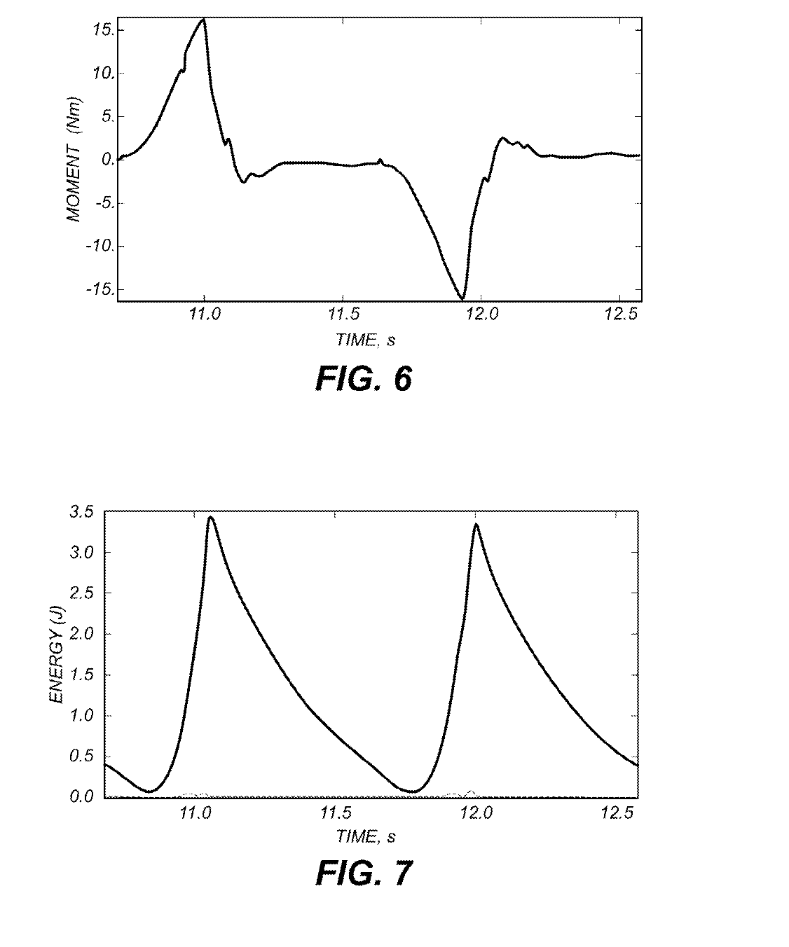

FIG. 6 shows results of a computer simulation of torque applied to the rod during a fly cast. The curve of FIG. 6 can be used to assess cast performance as measured by the wrist moment applied by angler 1 during casting. Parameters of the cast or tackle design can be adjusted to improve performance of the cast and casting tackle, e.g., to reduce the torque required to achieve a given distance of cast.

FIG. 7 shows results of a computer simulation of line kinetic energy during a fly cast. The curve of FIG. 7 can be used to assess cast performance as measured by line kinetic energy. Parameters of the cast or tackle design can be adjusted to improve performance, e.g., to impart more kinetic energy to the line for a given input energy or torque provided by angler 1.

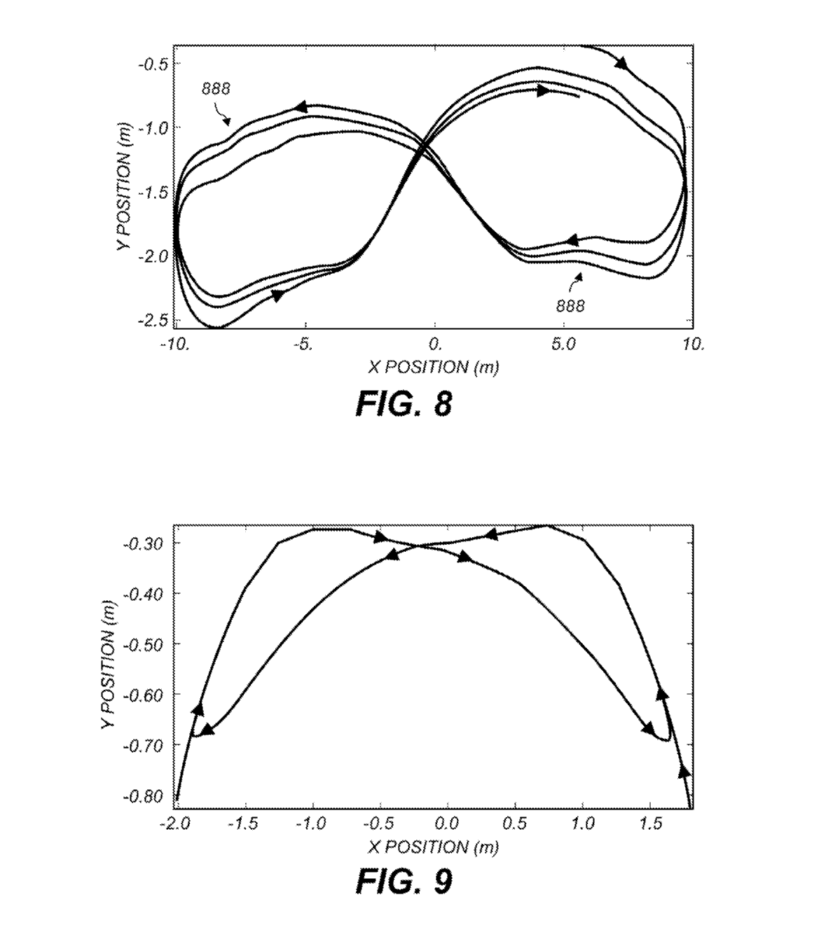

FIG. 8 shows results of a computer simulation of a fly path (i.e., a path of terminal tackle 6) during fly casting. For example, angler 1 can swing rod 3 back and forth to move terminal tackle 6 in the illustrated “figure-8” pattern. The curve of FIG. 8 can be used to assess of cast and casting tackle performance as measured by fly path during casting. The X position referenced on the plot is anterior/posterior to angler 1 and the Y position referenced on the plot is superior/inferior to the angler 1, using the terms of FIG. 1B. Cast or casting tackle parameters or designs can be adjusted to produce a smoother fly path that is free from undulations that occur within a single cast, or has reduced amplitude of undulations compared to other casts. The curve of FIG. 8 shows low-amplitude undulations 888. The fly path covers a range between −10.050 m and 9.738 m on the X axis and between −2.550 m and −0.362 m on the Y axis.

FIG. 9 shows results of a computer simulation of a path of a tip 7 of rod 3 during fly casting. In the illustrated example, angler 1 begins a cast by pulling tip 7 up and back (moving in a −X direction starting from −1.8 m). The cast can end with tip 7 at approximately (−2 m, −0.8 m). The curve of FIG. 9 can be used to assess cast performance as measured by rod tip path during fly casting. Cast or casting tackle parameters or designs can be adjusted to provide a rod tip path that is straight prior to the formation of a loop, since such paths can result in a tighter loop that is more efficient. The rod tip path covers a range between −2.017 m and 1.805 m on the X axis and between −0.825 m and −0.266 m on the Y axis.

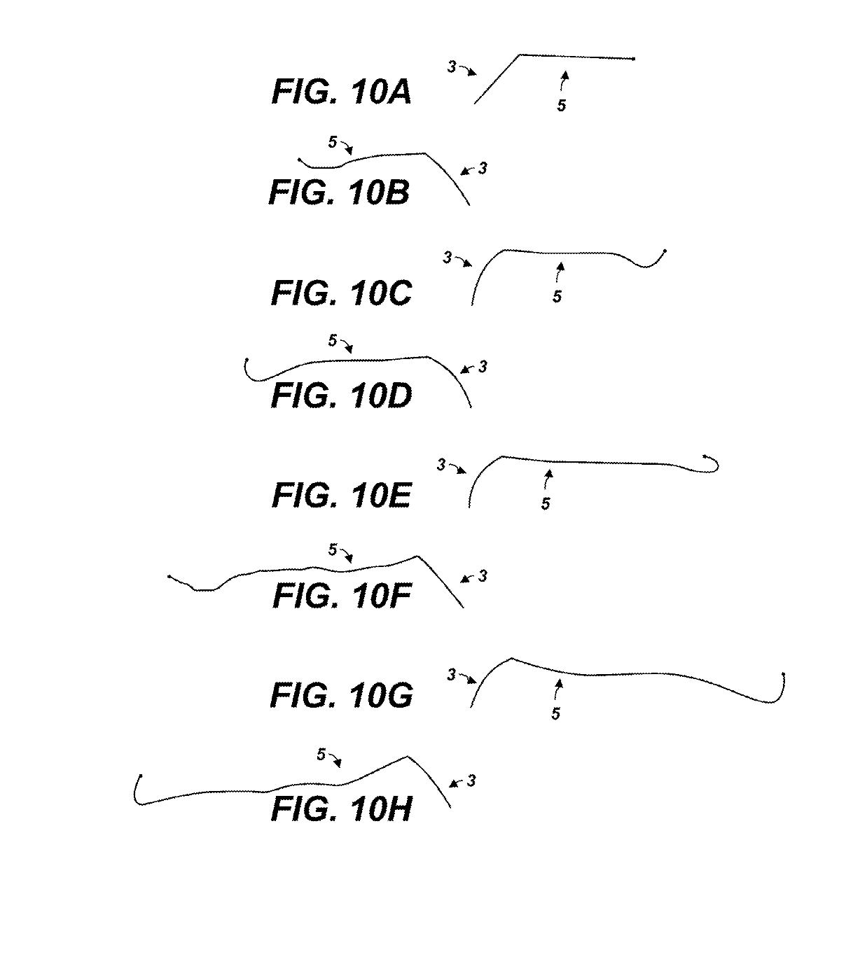

FIGS. 10A-10H show results of a simulation of fly casting that includes “line shooting,” i.e., the paying out of line. The configurations of rod 3 and line 5 are shown at each of a plurality of times. The illustrated cast definition can include the paying out of line (shooting) and the retrieval of line during casting (“hauling”). FIGS. 10A-10H show various times in a sequence of fly casting operations that include line shooting. FIGS. 10A, 10C, 10E, and 10G show forward casts, and FIGS. 10B, 10D, 10F, 10H show backward casts. In each forward and back cast, an amount of line 5 is allowed to pay out. Computer simulations can also be performed of casts in which a much greater length of line is allowed to pay out, or in which line is pulled in and allowed to shoot out in both the back and forward casts (“double haul” fly casting).

In various embodiments, casting using spinning gear, bait casting gear, and other conventional fishing tackle is modeled using a single cast definition.

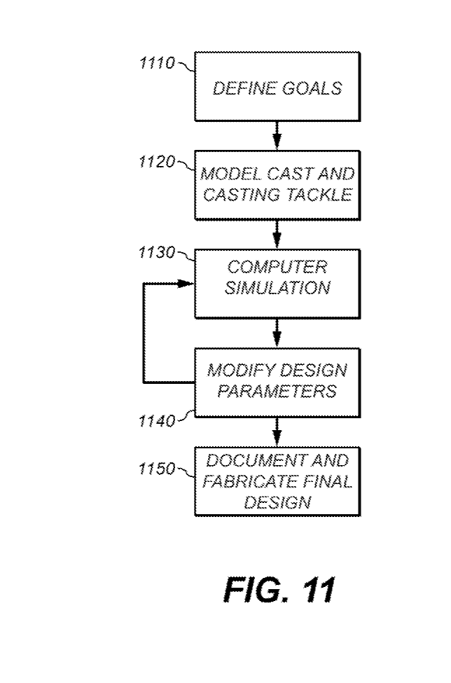

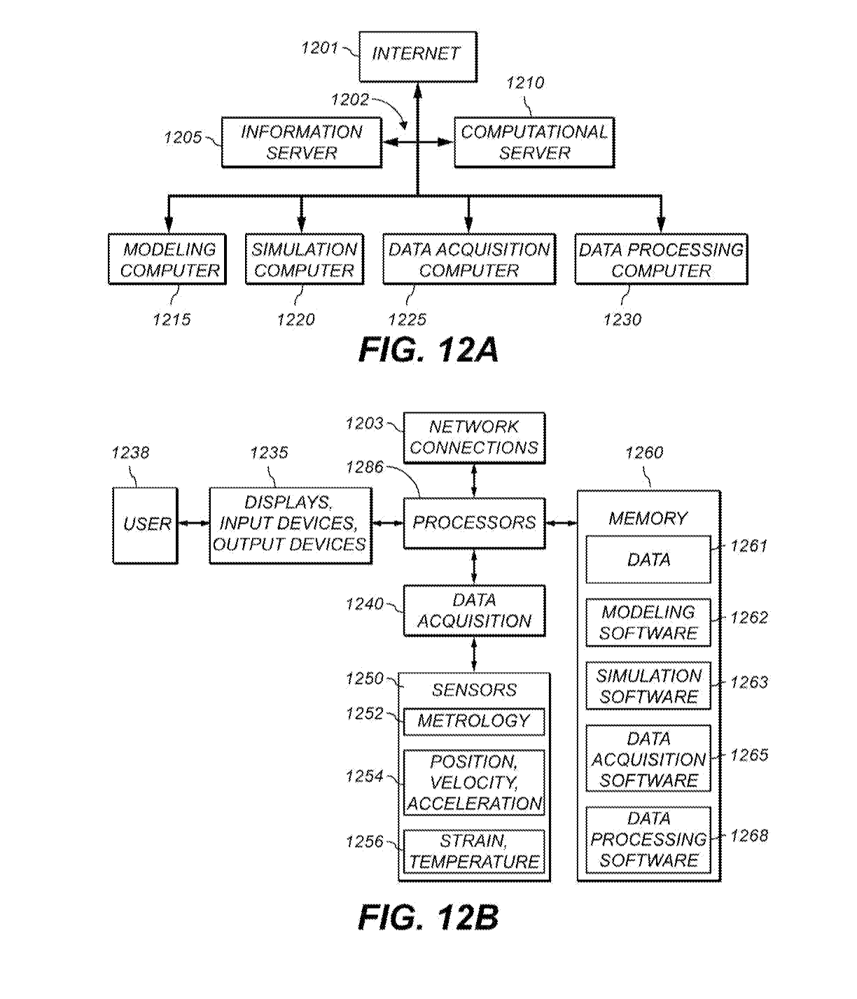

FIG. 11 shows a flowchart illustrating exemplary methods for simulating a cast of a fishing rod or designing a cast or casting tackle. The steps can be performed in any order except when otherwise specified, or when data from an earlier step is used in a later step. In at least one example, processing begins with step 1110. For clarity of explanation, reference is herein made to various components shown in FIGS. 1A, 12A, and 12B that can carry out or participate in the steps of the exemplary method. It should be noted, however, that other components can be used; that is, exemplary method(s) shown in FIG. 11 are not limited to being carried out by the identified components. Various steps and methods depicted can be implemented by a processor in an apparatus used in the design of casts and casting tackle.

In step 1110, cast and casting tackle goals are defined. In an example, the goal is to design a combined fly rod and fly cast that requires less energy input from the angler to maintain a 50 foot long false cast. A “false cast” is a series of forward and backward motions of rod 3 that maintain line 5 off the ground, extending, e.g., alternately 50 ft ahead of, then 50 ft behind angler 1. Alternative false casts can be shorter, e.g., extending 5-10 ft, or longer, e.g., extending 60 ft. Another exemplary false cast extends 30 ft. It is assumed that a specific fly line, leader and tippet are used and that they are not designed. In addition, the terminal tackle is a specific fly that is also not designed. The rod is assumed to have a circular cross-section with inside and outside diameters that vary along the length of the rod. Numerical parameter values corresponding to the defined goals are stored in transitory or non-transitory electronic memory accessible by a computer system. An example of transitory electronic memory is random-access memory; an example of a non-transitory electronic memory is Flash memory.

In step 1130, the computer system accesses non-transitory electronic storage to read, load, and execute a simulation program using the stored parameters to model the initial cast and casting tackle based on the stored parameter values. Modeling may occur on a single computer system or on several computers over a network. A server may or may not be used in the network. A high performance computing network may be used to locally or remotely provide computation resources. In modeling, all parameters that affect the goals are specified. Rod design parameters may include but are not limited to: material stiffness, strength, orientation, and density; rod length, inside diameter variation with length, and outside diameter variation with length; number of line guides, positions, and diameters. The cast is defined using the above described method with three design parameters (wrist angle which may include angular velocity in terms of numerical values, wrist translation which may include translational velocity in terms of numerical values, and the time required to achieve maximum velocity, for example).

In step 1130, a computer simulation, as described above, is executed by a processor of the computer system to predict cast performance. Step 1130 can also include estimating the energy input to the rod by the angler 1 in the cast definition.

In step 1140, the design parameters may be modified and the computer simulation and energy calculations (step 1130) repeated. In particular, one or more cast parameters may be varied and the outside diameter of the rod as a function of rod length may be varied. Step 1140 can be followed by step 1130. In this way, steps 1130, 1140 can be repeated until selected design goals are satisfied. The computer system may automate this step using mathematical-optimization algorithms (nonlimiting examples include linear, quadratic and nonlinear programming, conjugate gradients, Newton's method and variations, and genetic algorithms).

In step 1150, the results of optimization or simulation are documented. In step 1150, the computer system can output (e.g. display) resulting performance measurements, e.g., as tables of numerical values which have been populated by the simulation software calculating the cast performance in the simulation. The computer system may also output the simulated cast performance as a moving digital image, i.e. an animation or video, or a series of digital still images (e.g., FIGS. 5A-5P, 10A-10H). If the simulations included casting tackle, the resulting design of the casting tackle can be documented in, e.g., blueprint form, and can be fabricated.

Specifically, various aspects include a computer implemented method of simulating a cast of a fishing rod and a fishing line. In these aspects, step 1110 or step 1120 includes storing in electronic memory parameters of a first control aspect, the parameters of the first control aspect being configured to control a trajectory of the fishing line depicted by the simulation of the cast; and storing in the electronic memory parameters of a second control aspect, the parameters of the second control aspect being configured to control the trajectory of the fishing line depicted by the simulation of the cast. For example, the first control aspect can include an angular velocity of the fishing rod, and the parameters of the first control aspect can include a numerical value. Also or alternatively, the second control aspect can include a translational velocity of the fishing rod, and the parameters of the second control aspect can include a numerical value.

In various embodiments, step 1120 also includes storing in the electronic memory parameters representing physical characteristics of the fishing rod, the parameters representing the physical characteristics of the fishing rod being configured to control the trajectory of the fishing line depicted by the simulation of the cast. The parameters representing physical characteristics of the fishing can include at least one of a length of the fishing rod, a diameter of the fishing rod, and a modulus of elasticity of the material from which the fishing rod is made.

In various embodiments, step 1120 also includes storing in the electronic memory parameters of a third control aspect, the parameters of the third control aspect being configured to control a trajectory of the fishing line depicted by the simulation of the cast, wherein the third control aspect comprises a position of the fishing rod, and the parameters of the third control aspect include a numerical value.

In various embodiments, the parameters of the first control aspect include a beginning parameter representing a start time (t₀), an ending parameter representing a finish time (t₂), and a transitional parameter representing the first control aspect at a point in time (t₁) after the start time and before the finish time.

In various embodiments, the parameters of the second control aspect include a beginning parameter (t₀) representing a start time, an ending parameter (t₂) representing a finish time, and a transitional parameter representing the second control aspect at a point in time (t₁) after the start time and before the finish time.

In various embodiments, step 1120 further includes storing in electronic memory parameters of a terminal tackle. The parameters can include, e.g., weight, air resistance values such as flat plate area or drag, and position on line 5.

Step 1130 includes executing a simulation program to display the simulation of the cast, the simulation program based on the stored parameters of the first and second control aspects. Step 1140 includes modifying a stored parameter of at least one of the first and second control aspects and returning to step 1130. In this way, a second simulation of the cast is displayed based on the modified stored parameter of at least one of the first and second control aspects.

In various aspects, the modifying the stored parameter of at least one of the first and second control aspects in step 1140 includes the step of increasing or decreasing a numerical value of the stored parameter.

In some embodiments using second control aspects, step 1130 of executing a simulation program to display the simulation of the cast includes calculating a position of the fishing rod and of the fishing line based on the stored parameters of the first and second control aspects. A technical effect of at least these embodiments is, in step 1150, to display a moving image representing the fishing rod and the fishing line based on the step 1130 of calculating the position of the fishing rod and of the fishing line.

In various embodiments using terminal tackle, step 1130 of executing a simulation program to display the simulation of the cast includes calculating a position of the fishing line further based on the stored parameters of the terminal tackle. For example, the effect on tip 16 due to gravitational force acting on the terminal tackle (e.g., a fly) can be determined and accounted for in the simulation.

In various embodiments, the cast is designed by specifying cast and casting tackle design parameter values, performing a computer simulation of casting and assessing cast performance. Cast design parameter values are changed until acceptable cast performance is achieved.

In various embodiments, the rod is designed by specifying cast and casting tackle design parameter values, performing a computer simulation of casting and assessing cast performance. Rod design parameter values are changed until acceptable cast performance is achieved.

In various embodiments, the line is designed by specifying cast and casting tackle design parameter values, performing a computer simulation of casting and assessing cast performance. Line design parameter values are changed until acceptable cast performance is achieved.

In various embodiments, the terminal tackle is designed by specifying cast and casting tackle design parameter values, performing a computer simulation of casting, and assessing cast performance. Terminal tackle design parameter values are changed until acceptable cast performance is achieved.

In various embodiments, the cast and casting tackle are designed through simultaneous design of the cast, rod, line, and terminal tackle or through independent or simultaneous design of any subset of these components.

FIGS. 12A-12B show exemplary apparatus for model calibration, verification, and validation. According to various embodiments, measurements of the cast and casting tackle are made and compared to computer simulation predictions to assess the quality of the simulation. Measurements of angler 1, rod 3, line 5, and terminal tackle 6 positions as a function of time are made using metrology techniques (e.g. photogrammetry and videogrammetry techniques). Sensors are placed on the casting tackle or angler 1 (e.g., any or all of components 2, 4, 10, 3, 7, 5, or 6 shown in FIG. 1) to measure component position/rotation, velocity/angular velocity and acceleration/angular acceleration (e.g. accelerometers, gyroscopes, inertia measurement units). Sensors may also be placed on the rod 3 to measure temperature and strain (e.g. thermocouples, thermistors, strain gages). These features can more generally be used as input to the computer simulation because they provide direct measurements of component behavior. The measurement apparatus includes computers systems for digital data acquisition and processing. The computer systems may be connected through a computer network to the each other and the internet to facilitate data exchange and processing.

Various embodiments herein may advantageously be used to design new casts and casting tackle or to improve the design of existing casts and casting tackle.

The apparatus employs computer network systems, computer systems, and non-transitory instruction media as shown in FIG. 12A and FIG. 12B. A computer network 1202 can be connected to the internet 1201 and is used for information sharing and distributing as well as for computational resources. Exemplary computer systems 1205, 1210, 1215, 1220, 1225, 1230 can be connected to network 1202 and can include any or all of:
Processors 1286;
Memory 1260 containing the modeling 1262, simulation 1263, data acquisition 1265, and data processing 1268 non-transitory instruction media (all of which can be one and the same non-transitory computer-readable storage medium, or any number >1 of such media)
Digital displays, input, and output devices 1235 for communication between processors 1286 and user(s) 1238;
Network and internet connections 1203;
Data acquisition devices 1240;
electronic memory 1260 including local or remotely accessible data storage 1261; and
Sensors 1250 for measuring rod cast and casting tackle characteristics, including metrology devices 1252, motion sensors 1254 (e.g., position, velocity, or acceleration sensors), or physical sensors 1256 (e.g., strain or temperature sensors).

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network 1202, including a local area network (LAN) or a wide area network (WAN), or the connection may be made to an external computer (for example, through the Internet 1201 using an Internet Service Provider).

Aspects of the present invention are described herein with reference to flowchart illustrations and/or block diagrams of methods, apparatus (systems) and computer program products according to embodiments described herein. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor 1286 of the computer or other programmable data processing apparatus 1230, create devices for implementing the functions/acts specified in the flowchart and/or block diagram block or blocks (e.g., blocks shown in FIG. 11).

These computer program instructions may also be stored in a tangible non-transitory computer readable medium that can direct a computer, other programmable data processing apparatus, or other devices to function in a particular manner, such that the instructions stored in the tangible non-transitory computer readable medium produce an article of manufacture including instructions which cause the processor 1286 to implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose embodiments, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The invention is inclusive of combinations of the aspects described herein. References to “a particular aspect” (or “embodiment” or “version”) and the like refer to features that are present in at least one aspect of the invention. Separate references to “an aspect” (or “embodiment”) or “particular aspects” or the like do not necessarily refer to the same aspect or aspects; however, such aspects are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention.

What is claimed is:

1. A computer implemented method of simulating a cast of a fishing rod and fishing line, the method comprising:
storing in electronic memory parameters of a first control aspect, the parameters of the first control aspect being configured to control a trajectory of the fishing line depicted by the simulation of the cast;
storing in the electronic memory parameters of a second control aspect, the parameters of the second control aspect being configured to control the trajectory of the fishing line depicted by the simulation of the cast; and
executing a simulation program to display the simulation of the cast, the simulation program based on the stored parameters of the first and second control aspects.

2. The computer implemented method of claim 1, further comprising modifying a stored parameter of at least one of the first and second control aspects and displaying a second simulation of the cast based on the modified stored parameter of at least one of the first and second control aspects.

3. The computer implemented method of claim 2, wherein the step of modifying the stored parameter of at least one of the first and second control aspects includes the step of increasing or decreasing a numerical value of the stored parameter.

4. The computer implemented method of claim 3, wherein the first control aspect comprises an angular velocity of the fishing rod, and wherein the parameters of the first control aspect include a numerical value.

5. The computer implemented method of claim 4, wherein the second control aspect comprises a translational velocity of the fishing rod, and wherein the parameters of the second control aspect include a numerical value.

6. The computer implemented method of claim 5, further comprising storing in the electronic memory parameters representing physical characteristics of the fishing rod, the parameters representing the physical characteristics of the fishing rod being configured to control the trajectory of the fishing line depicted by the simulation of the cast.

7. The computer implemented method of claim 6, wherein the parameters representing physical characteristics of the fishing include at least one of a length of the fishing rod, a diameter of the fishing rod, and a modulus of elasticity of the material from which the fishing rod is made.

8. The computer implemented method of claim 5, further comprising storing in the electronic memory parameters of a third control aspect, the parameters of the third control aspect being configured to control a trajectory of the fishing line depicted by the simulation of the cast, wherein the third control aspect comprises a position of the fishing rod, and wherein the parameters of the third control aspect include a numerical value.

9. The computer implemented method of claim 4, wherein the parameters of the first control aspect include a beginning parameter representing a start time, an ending parameter representing a finish time, and a transitional parameter representing the first control aspect at a point in time after the start time and before the finish time.

10. The computer implemented method of claim 5, wherein the parameters of the second control aspect include a beginning parameter representing a start time, an ending parameter representing a finish time, and a transitional parameter representing the second control aspect at a point in time after the start time and before the finish time.

11. The computer implemented method of claim 10, wherein the step of executing a simulation program to display the simulation of the cast includes:
calculating a position of the fishing rod and of the fishing line based on the stored parameters of the first and second control aspects; and
displaying a moving image representing the fishing rod and the fishing line based on the step of calculating the position of the fishing rod and of the fishing line.

12. The computer implemented method of claim 1, further comprising storing in electronic memory parameters of a terminal tackle, wherein the step of executing a simulation program to display the simulation of the cast includes calculating a position of the fishing line further based on the stored parameters of the terminal tackle.
